(19) United States
(12) Patent Application Publication
(10) Pub. No.: US 2018/0101658 A1
(43) Pub. Date: Apr. 12, 2018

(54) METHOD OF AND SYSTEM FOR DETERMINING RISK OF AN INDIVIDUAL TO CONTRACT CLOSTRIDIUM DIFFICILE INFECTION

(71) Applicants: Samuel Sunday Nokuri, Dayton, MD (US); Ofundem Nokuri, Dayton, MD (US)

(72) Inventors: Samuel Sunday Nokuri, Dayton, MD (US); Ofundem Nokuri, Dayton, MD (US)

(21) Appl. No.: 15/679,059

(22) Filed: Aug. 16, 2017

Related U.S. Application Data
(60) Provisional application No. 62/406,100, filed on Oct. 10, 2016.

(51) Int. Cl. G06F 19/00

(52) U.S. Cl. CPC G06F 19/3431; G06F 19/363; G06F 19/322

(57) ABSTRACT

Disclosed is a system for determining risk of an individual to contract Clostridium Difficile (C-Diff). The system may include a communication device configured to transmit a plurality of assessment questions to a user device. Further, the plurality of assessment questions may correspond to C-Diff. Furthermore, the user device may be configured to present the plurality of assessment questions. Additionally, the communication device may be configured to receive a plurality of responses to the plurality of assessment questions from the user device. The plurality of responses may correspond to the individual. Additionally, the communication device may be configured to receive demographic information associated with the individual. Further, the system may include a processing device configured to analyze each of the plurality of responses and the demographic information. Furthermore, the processing device may be configured to generate a risk stratification score based on the analysis.

The current application claims a priority to the U.S. Provisional Patent application Ser. No. 62/406,100 filed on Oct. 10, 2016.

### FIELD OF THE INVENTION

The present disclosure generally relates to determining risk of contracting Clostridium Difficile (C-Diff). More specifically, the present disclosure relates to a computer implemented methods and systems for determining risk of an individual to contract C-Diff.

### BACKGROUND OF THE INVENTION

Clostridium Difficile (C-Diff) still remains one of the most common healthcare and community associated infections. According to studies, between 1996 and 2009, C-Diff infection rates in United States for hospitalized patients with ages greater than or equal to 65 years increased by 200%. Further, in 2011, 29000 patients died within 30 days after contracting C-Diff because of delay in diagnosis and treatment. In addition to causing mortality and morbidity, C-Diff infections result in several thousand dollars in hospital costs for primary infections and tens of thousands of dollars per case for recurrent infections. Consequently, it has been estimated that about $1.1 billion is spent annually in treating C-Diff infections throughout the United States.

Currently, existing clinical practices lack cost-effective proactive interventions and means for focusing such interventions based on risk. Although some risk factors are well known among clinicians, the conventional process of personally interacting with patients in order to obtain relevant information for estimating risk of C-Diff is burdensome, time-consuming and fraught with uncertainties.

Therefore, there is a need for methods and systems that can facilitate detecting risk of contracting C-Diff among individuals.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a computer implemented method (also referred to herein as “the method”) of determining risk of an individual to contract Clostridium Difficile (C-Diff). The method may include presenting, using a presentation device, a plurality of assessment questions corresponding to C-Diff. Further, the method may include receiving, using a processor, a plurality of responses to the plurality of assessment questions. Furthermore, the plurality of responses may correspond to the individual. Additionally, the method may include receiving, using the processor, demographic information associated with the individual. Further, the method may include analyzing, using the processor, each of the plurality of responses and the demographic information. Furthermore, the method may include generating, using the processor, a risk stratification score based on the analyzing.

Further disclosed is a system for determining risk of an individual to contract Clostridium Difficile (C-Diff). The system may include a communication device configured to transmit a plurality of assessment questions to a user device. Further, the plurality of assessment questions may correspond to C-Diff. Furthermore, the user device may be configured to present the plurality of assessment questions. Additionally, the communication device may be configured to receive a plurality of responses to the plurality of assessment questions from the user device. The plurality of responses may correspond to the individual. Additionally, the communication device may be configured to receive demographic information associated with the individual. Further, the system may include a processing device configured to analyze each of the plurality of responses and the demographic information. Furthermore, the processing device may be configured to generate a risk stratification score based on the analysis.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a flowchart of a method of determining a risk of contracting Clostridium Difficile (C-Diff), in accordance with some embodiments.

FIG. 2 illustrates a flowchart of a method of predicting a potential spread of C-Diff based on analysis of patient records, in accordance with some embodiments.

FIG. 3 illustrates a flowchart of a method of adapting a C-Diff risk determination questionnaire based on diagnostic information associated with C-Diff, in accordance with some embodiments.

FIG. 4 illustrates a flowchart of a method of determining a risk of contracting Clostridium Difficile (C-Diff) based on sensor data from at least one monitoring device associated with an individual, in accordance with some embodiments.

FIG. 5 illustrates a system for determining a risk of contracting C-Diff, in accordance with various embodiments.

FIG. 6 illustrates a user interface configured to present a plurality of assessment questions and receive a plurality of responses in order to determine a risk of contracting C-Diff, in accordance with some embodiments.

FIG. 7 illustrates a user interface configured to present a risk of contracting C-Diff based on a plurality of responses to a plurality of assessment questions for an exemplary patient, in accordance with some embodiments.

FIG. 8 illustrates a user interface configured to present a risk of contracting C-Diff based on a plurality of responses to a plurality of assessment questions for another exemplary patient, in accordance with some embodiments.

FIG. 9 illustrates a user interface configured to display patent records comprising risk of contracting C-Diff for each patient, in accordance with some embodiments.

FIG. 10 illustrates a graphical representation of a plurality of risk scores of contracting C-Diff associated with an individual at different times, in accordance with some embodiments.

FIG. 11 illustrates a graphical representation of a trend in C-Diff score over a period of time, in accordance with some embodiments.

FIG. 12 illustrates a graphical representation of a launch screen of a mobile app for determining a risk of contracting C-Diff, in accordance with various embodiments.

FIG. 13 illustrates a graphical representation of a login screen of the mobile app for determining a risk of contracting C-Diff, in accordance with various embodiments.

FIG. 14 illustrates a user interface of the mobile app configured to receive a response to an assessment question for determining a risk of contracting C-Diff, in accordance with various embodiments.

FIG. 15 illustrates a user interface of the mobile app configured to display recommendations for Pediatric C-Diff Infection, in accordance with various embodiments.

FIG. 16 Illustrates different exemplarily categories within the selected category.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of determining risk of contracting C-Diff, embodiments of the present disclosure are not limited to use only in this context. For example, the disclosed techniques may be used to determine risk associated with a variety of clinical and non-clinical conditions.

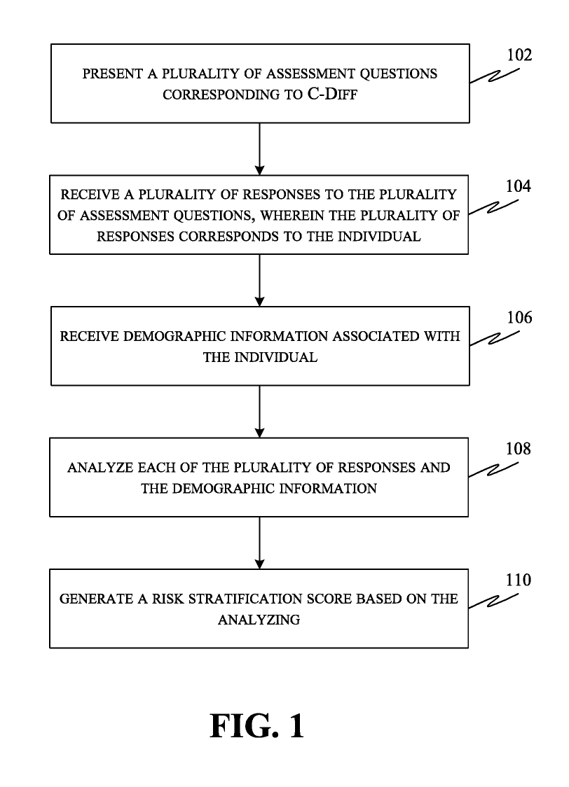

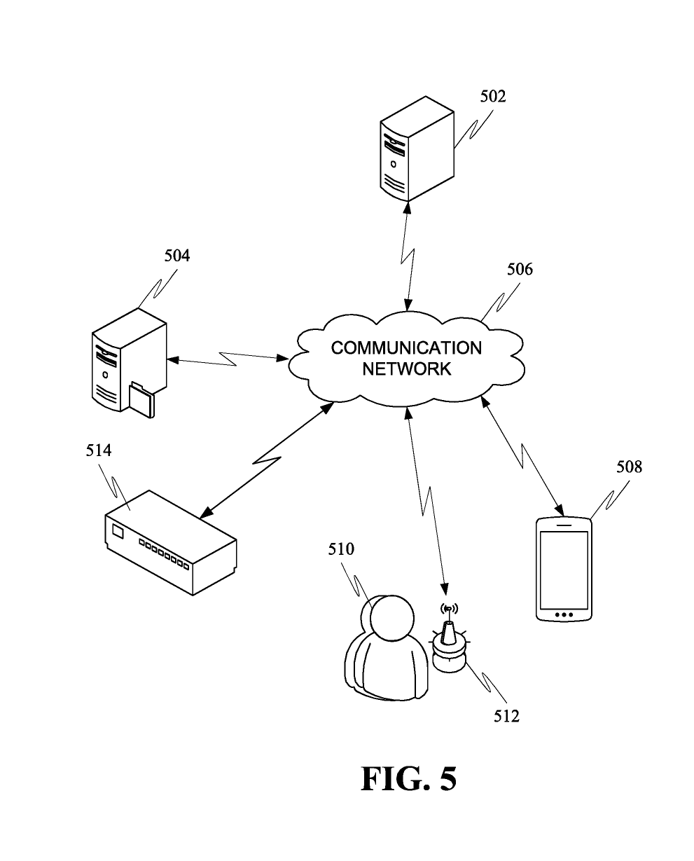

FIG. 1 illustrates a flowchart of a method 100 of determining a risk of contracting Clostridium Difficile (C-Diff), in accordance with some embodiments. The method 100 may be a computer implemented method. Accordingly, one or more stages of the method 100 may be performed by a computing device such as, for example, a server computer, a laptop computer, the tablet computer, a smart phone etc. For example, in some embodiments, the system 500 explained in detail in conjunction with FIG. 5 may perform one or more stages of the method 100.

The method 100 may include a stage 102 of presenting, using a presentation device, a plurality of assessment questions corresponding to C-Diff. In general, the plurality of assessment questions may be directed towards obtaining information relevant to assessing a risk of contracting C-Diff. For instance, the plurality of assessment questions may relate to a clinical symptom exhibited by the individual (observed by the individual and/or a physician), lifestyle of the individual, behavioral patterns of the individual, demographic information of the individual, environmental data of the individual, medical history of the individual, prescribed drug consumption and so on. For instance, the medical history may include one or more of history of C-Diff infection, immunocompromised disease, inflammatory bowel disease, consumption of antibiotics and consumption of proton pump inhibitors. Additionally, the medical history may indicate one or more of a frequency of diarrhea, abdominal pain, fever accompanied with increased white blood cell count, renal impairment, lactic acidosis and low albumin level.

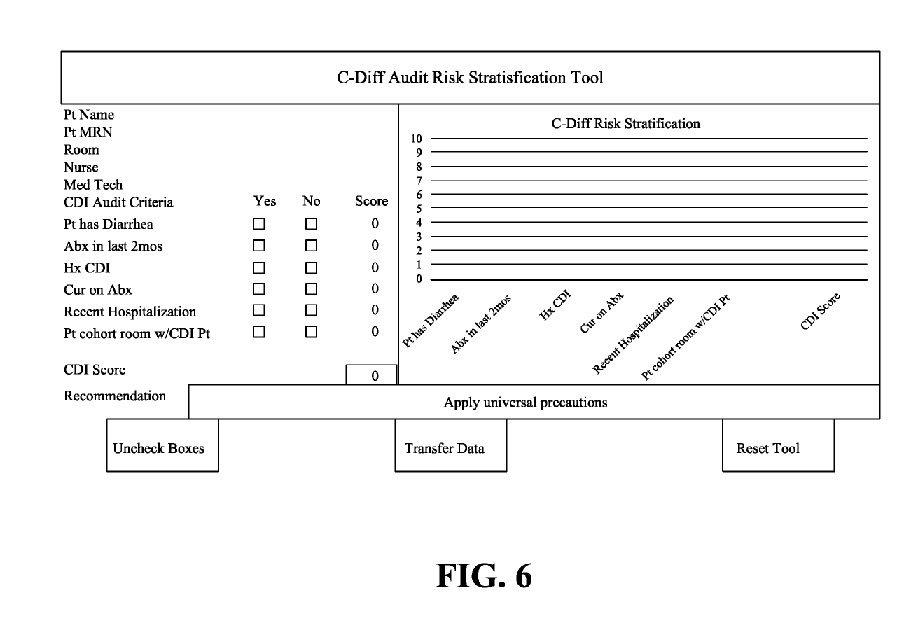

Accordingly, in an exemplary instance, as illustrated in FIG. 6, the plurality of assessment questions may include: a) has the individual experienced episode of diarrhea recently? b) Has the individual consumed antibiotics in the past two months? c) Has the individual contracted C-Diff infection in the past? d) Cur on Abx? e) Has the individual been recently hospitalized? Was the individual hospitalized in a cohort room with other patients infected with C-Diff?

In an embodiment, the plurality of assessment questions may be constructed by a medical professional based on prior knowledge and experience. Accordingly, a user interface may be provided in order to enable the medical professional to add, delete or modify the plurality of assessment questions. Subsequently, the plurality of assessment questions may be stored in a storage device.

In another embodiment, the plurality of assessment questions may be automatically generated based on machine learning. For instance, an artificial neural network may be used to perform supervised and/or unsupervised learning of a large body of patient information (for example, but not limited to, patient records) of individuals who have been reported as being infected with C-Diff. Accordingly, the artificial neural network may discover a plurality of correlates corresponding to C-Diff infection. In some embodiments, the plurality of correlates identified by the artificial neural network may be presented to a medical professional on a user interface for review. Accordingly, the medical professional may be enabled to add, delete and/or modify the plurality of correlates based on medical knowledge and expertise. Subsequently, using natural language processing techniques, the plurality of assessment questions may be automatically generated in order to obtain information from the individual regarding the plurality of correlates.

Further, the presentation device may be configured to present the plurality of assessment questions through one or more sensory modalities. For instance, the presentation device may include one or more of a display device, a sound generating device, a tactile display (e.g. Braille display) and so on. In some embodiments, the presenting may be performed on a user device, such as, a smartphone operated by a user. The user may be for example, a health care provider (e.g. clinician, physician, nurse, medical researcher etc.), a healthy individual, a hospitalized individual, and so on.

Accordingly, the presentation device may be located in different places in various scenarios. For instance, the presentation device may be situated at a hospital and operated by one or more of a health care provider and a patient. In another instance, the presentation device may be comprised in a mobile device (e.g. smartphone) of an individual. Accordingly, in such cases, the plurality of assessment questions may be transmitted to the mobile device from a server such as, system 500.

Further, the method 100 may include a stage 104 of receiving, using a processor, a plurality of responses to the plurality of assessment questions. Furthermore, the plurality of responses may correspond to the individual. In some embodiments, the plurality of responses may be provided by a medical professional. Accordingly, the plurality of responses may be received from user interface of a user device operated by the medical professional. For example, a stationary computing device situated at the hospital may be used by the medical professional in order to provide the plurality of responses. Alternatively, and/or additionally, in some embodiments, the plurality of responses may be received from the individual and/or another person (e.g. family member, colleague, friend etc.) on behalf of the individual. Accordingly, the plurality of responses may be received from a user device operated by the individual (or the another person) such as, but not limited to, a mobile device. Accordingly, the method 100 may include receiving the plurality of responses from the mobile device over a communication network.

In general, the plurality of responses may be such that they provide relevant information on the basis of which a risk of contracting C-Diff may be determined. In some embodiments, a set of predetermined responses comprising the plurality of responses may be presented to the individual. For example, for an assessment question, multiple predetermined responses may be presented on the user interface. Accordingly, the user may be enabled to select one or more of the multiple predetermined responses in order to answer the assessment question. Further, in an instance, the plurality of responses may be of binary form. Accordingly, for each of the plurality of assessment questions, a corresponding response may be either YES or NO.

Alternatively, in other embodiments, a response to an assessment question of the plurality of assessment questions may be of non-binary form. Accordingly, for example, a response to an assessment question on the frequency of diarrhea recently experienced by the individual, the response may be a numerical value (e.g. 3 times a day). Further, in some embodiments, the response may include a natural language speech or text. For instance, the response may be a narrative provided by the individual and/or a physician. Accordingly, in such cases, the plurality of responses may be subjected to speech to text and/or natural language processing in order to extract relevant information associated with a corresponding assessment question.

In some embodiments, the plurality of responses may be generated by a bot (automated software agent) based on information associated with the individual. For example, the bot may be configured to automatically access relevant information from sources such as, but not limited to, patient records and analyze the relevant information in order to construct the plurality of responses. In addition, the bot may be configured to access real-time and/or stored data from sensors comprised in at least one monitoring device, such as, but not limited to, wearable electronic devices associated with the individual. For example, the sensors may be configured to detect one or more conditions which are determined to be risk factors for contracting C-Diff. For example, a sensor comprised in an automated pill dispenser may be configured to detect dispensing of antibiotics to the individual. Accordingly, the bot may be configured to communicate with the automated pill dispenser in order to establish consumption of antibiotics by the individual. Similarly, the sensor may include an image sensor configured to capture a visual of the individual's stool and perform image analysis in order to determine presence of diarrhea. Likewise, the sensor may include a location sensor which may reveal past visits to a hospital and/or to a ward with C-Diff infected patients. As a result of automatically retrieving such relevant information, a burden of the individual and/or a medical professional to provide the plurality of responses may be eliminated, at least in part.

Additionally, the method 100 may include a stage 106 of receiving, using the processor, demographic information associated with the individual, such as, but not limited to, age, gender, residence, occupation, behavioral information, etc. In an instance, the demographic information may be received from a user device operated by the individual and/or another user acting on behalf of the individual. Accordingly, the method 100 may include presenting a user interface on the user device of the individual in order to receive the demographic information. Further, once the individual has provided the demographic information, the method 100 may include receiving, using a communication interface, the demographic information transmitted by the user device. Alternatively, and/or additionally, the demographic information may be received from a database (e.g. EMR database) comprising the demographic information of the individual. For instance, typically a patient record of the individual may include demographic information. Accordingly, the method may include receiving, using the communication interface, the demographic information from the database.

Although method 100 is shown to include the stage 106, in some embodiments, the stage 106 may be comprised in stage 104. In other words, the demographic information may be received in the form of the plurality of responses. Accordingly, the plurality of assessment questions may be directed towards obtaining the demographic information.

Further, the method 100 may include a stage 108 of analyzing, using the processor, each of the plurality of responses and the demographic information. The analyzing may include, for example, comparing each of the plurality of responses and the demographic information with a predetermined set of risky and/or non-risky values. For example, the demographic information including age of the individual may be compared with a threshold number (e.g. 65) since risk of C-Diff infection among the elderly is significantly higher. Similarly, the plurality of responses may be analyzed by comparing each response with a risky value, such as for example ‘YES’. For instance, such analyzing may determine if the plurality of responses provided by the individual to the plurality of assessment questions listed in FIG. 6 are each equal to YES.

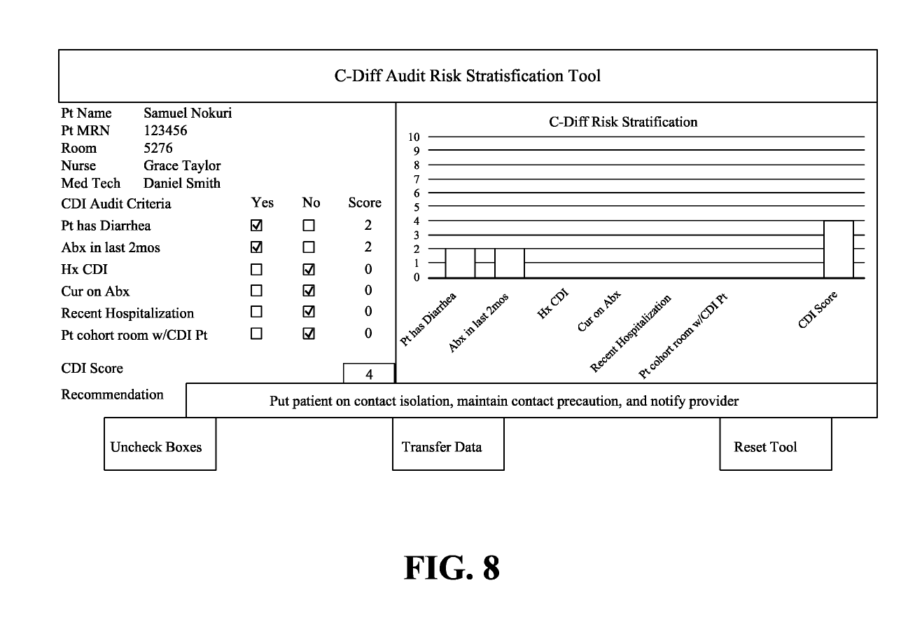

Furthermore, the method 100 may include a stage 110 of generating, using the processor, a risk stratification score based on the analyzing. For example, based on the analysis, it may be determined that age of the individual is greater than 65 and that the individual had recently consumed antibiotics, experienced diarrhea and was hospitalized. Accordingly, a relatively higher risk stratification score may be generated for the individual. Further, the risk stratification score may be generated based on combining sub-scores corresponding to the plurality of assessment questions and/or the demographic information. For example, as illustrated in FIG. 6, corresponding to each assessment question, a subscore may be generated based on analysis of a corresponding response. For example, as illustrated in FIG. 8, for the hypothetical individual named Nokuri, a subscore of 2 may be generated based on analysis of a response ‘YES’ to the assessment question “Has the individual (or patient) suffered from diarrhea?”. Similarly, a subscore of 2 may be generated based on analysis of a response ‘YES’ to the assessment question “Has the individual (or patient) consumed antibiotics in the past two months?”. Consequently, the plurality of subscores may be combined, using for example, but not limited to, summation in order to generate the risk stratification score (i.e. 4 as illustrated in FIG. 8).

Accordingly, in some embodiments, the plurality of assessment questions may be associated with a plurality of weights. Further, analyzing the plurality of responses may further be based on the plurality of weights. For example, as shown in FIG. 8, the subscores for each assessment question corresponds to a weight. For instance, as shown, both the first question and the second question (i.e. “Has the individual (or patient) suffered from diarrhea?” and “Has the individual (or patient) consumed antibiotics in the past two months?”) are accorded identical weight (i.e. 2). However, a weight accorded to another assessment question, for example, “Was the individual hospitalized in a cohort room with other patients infected with C-Diff?” may be accorded a higher weight (e.g. 4) since this may be a relatively stronger risk factor compared to the first question and the second question.

In some embodiments, the method 100 may further include generating, using the processor, a recommendation based on the risk stratification score. The recommendation may include one or more of a laboratory test, an imaging, and a treatment regimen.

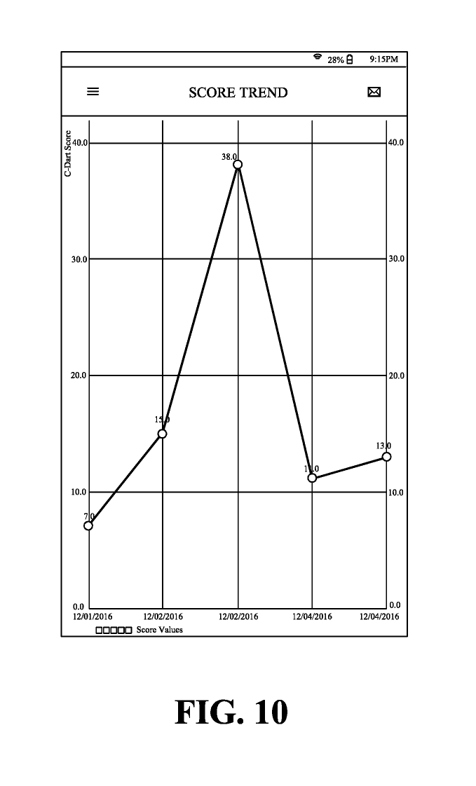

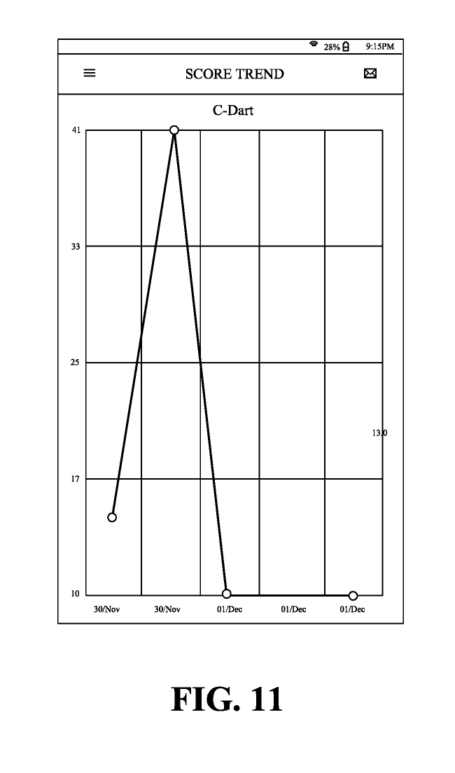

In some embodiments, the plurality of responses may be repeatedly obtained at a plurality of time instants. Further, a plurality of risk stratification scores corresponding to the plurality of time instants may be generated by the processor. As a result, the individual may be monitored over a period of time with regard to risk of contracting C-Diff. In some embodiments, the method 100 may further include identifying, using the processor, a trend in the plurality of risk stratification scores. For instance, as illustrated in FIG. 10 and FIG. 11, abrupt increase of the risk stratification score from a previously observed value or a baseline range of values may alert the medical professional and/or the individual to take precautionary measures.

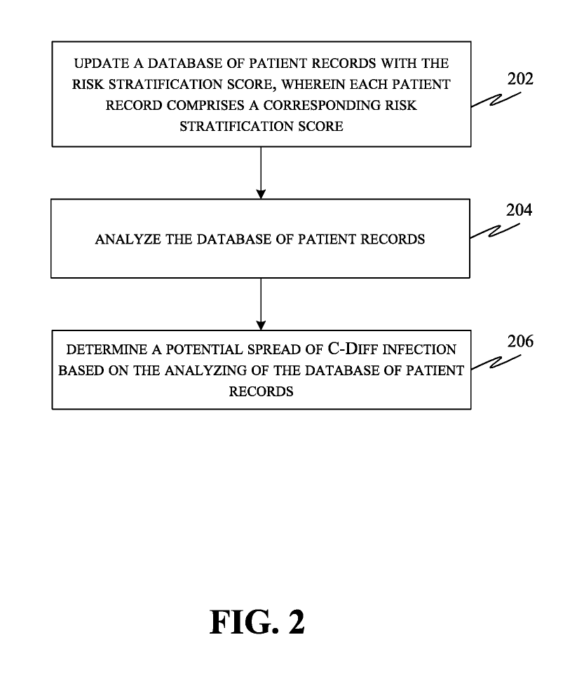

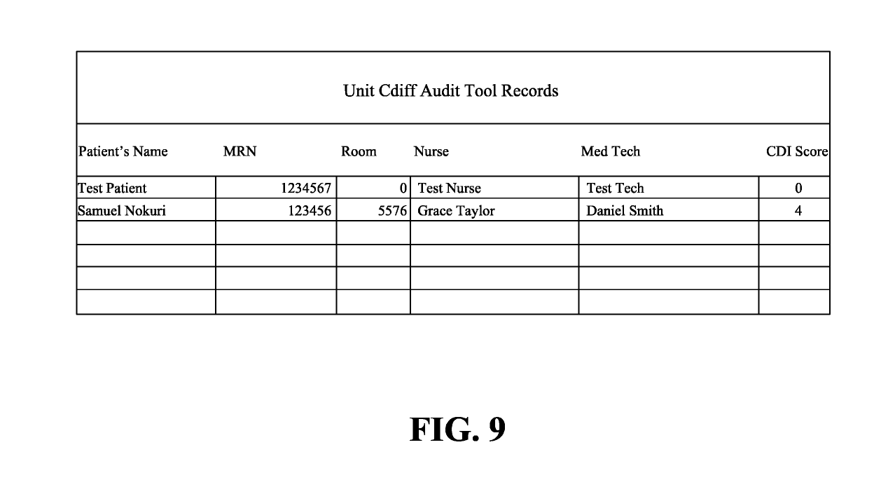

FIG. 2 illustrates a flowchart of a method 200 of predicting a potential spread of C-Diff based on analysis of patient records, in accordance with some embodiments. The method 200 may include a stage 202 of updating, using the processor, a database of patient records with the risk stratification score. Further, each patient record may include a corresponding risk stratification score. For example, as illustrated in FIG. 9, each row corresponding to a patient may be updated with a risk stratification score automatically determined for the patient. Additionally, the method 200 may include a stage 204 of analyzing, using the processor, the database of patient records. For example, the analysis may include statistical analysis while also considering demographic information of the patients. For instance, the analysis may determine the number of individuals with a relatively high risk stratification scores who are related to one another based on some commonality (e.g. occupation, location, etc.). Further, such analysis may provide useful insights and/or warnings of outbreaks. Accordingly, the method 200 may include a stage 206 of determining, using the processor, a potential spread of C-Diff infection based on the analyzing of the database of patient records.

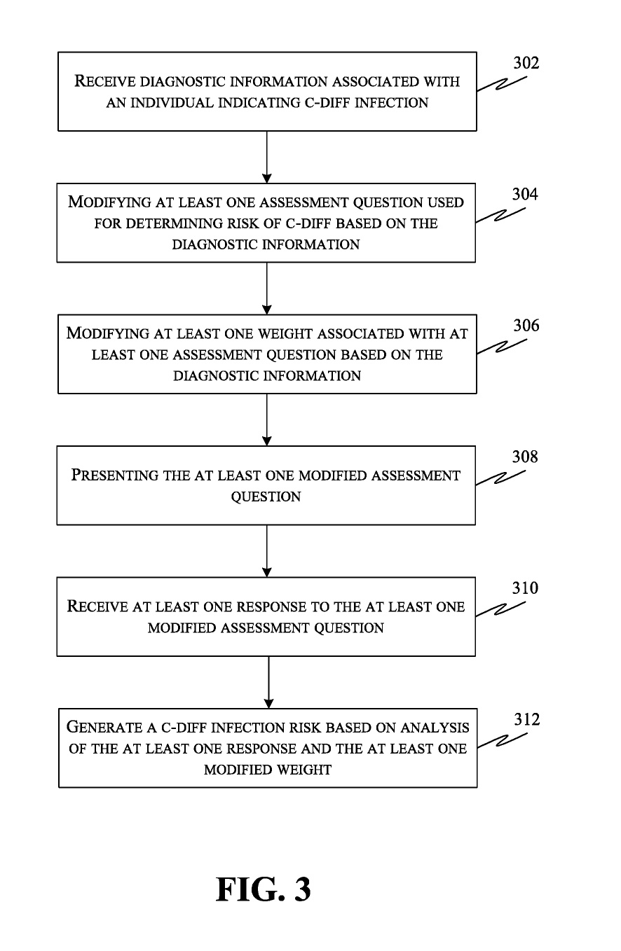

FIG. 3 illustrates a flowchart of a method 300 of adapting a C-Diff risk determination questionnaire based on diagnostic information associated with C-Diff, in accordance with some embodiments. The method 300 may include a stage 302 of receiving, using a processor, diagnostic information associated with the individual. Further, the individual may be reported as being infected with C-Diff. Such diagnostic information may be received from one or more sources such as a patient database, diagnostic laboratory, laboratory technician, the individual etc. Further, the method 300 may include a stage 304 of modifying, using the processor, at least one assessment question of the plurality of assessment questions. For example, diagnostic information associated with a large number of C-Diff infected individuals who were previously accorded a low risk stratification score may indicate at least one assessment question to be deficient. Accordingly, the at least one assessment question may be deleted or modified. The modifying may be performed either by a medical professional and/or by a bot (i.e. artificial intelligence). Further, the method 300 may include a stage 306 of modifying, using the processor, at least one weight associated with the at least one assessment question based on the diagnostic information. For example, based on an analysis of C-Diff risk stratification scores accorded to a plurality of C-Diff infected individuals, it may be determined that some assessment questions were not given sufficient weight. Therefore, the weight of these assessment questions may be increased automatically. Consequently, a modified plurality of assessment questions may be obtained based on modifying the at least one assessment question and/or modifying at least one weight associated with the at least one assessment question. Accordingly, the method 300 may include a stage 308 of presenting, using a presentation device, the at least one modified assessment question to other users and/or the individual. Further, the method 300 may include a stage 310 of receiving, using the processor, at least one response to the at least one assessment question. Additionally, the method 300 may include a stage 312 of generating a C-Diff infection risk based on analysis of the at least one response. In some embodiments, the C-Diff infection risk may supplement the risk stratification score computed for the individual based on the plurality of assessment questions. Accordingly, by adaptively modifying the plurality of assessment questions based on diagnostic information of individuals, a reliability of the risk stratification score may be improved.

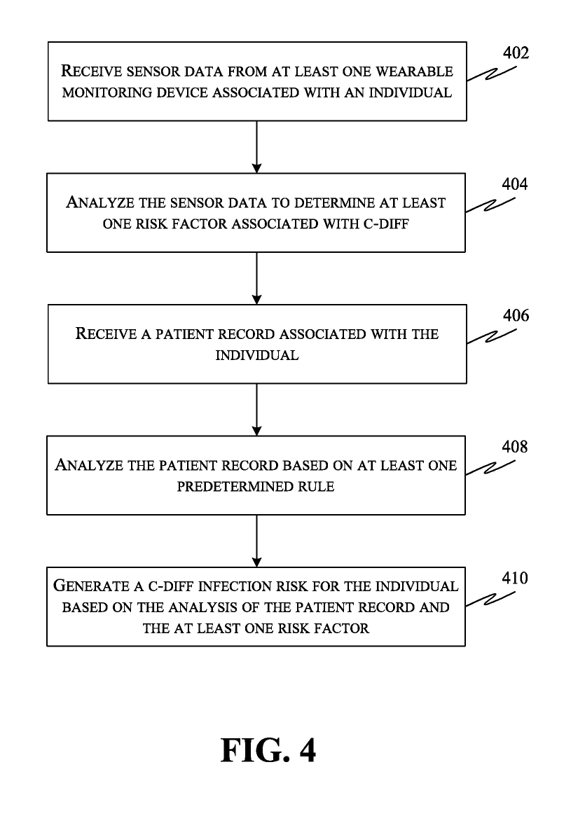

FIG. 4 illustrates a flowchart of a method 400 of determining a risk of contracting Clostridium Difficile (C-Diff) based on sensor data from at least one monitoring device associated with an individual, in accordance with some embodiments. The method 400 may include a stage 402 of receiving sensor data from at least one wearable monitoring device associated with the individual. Alternatively, in some embodiments, the sensor data may be received from a stationary monitoring device as well. Examples of the at least one wearable monitoring device may include, but are not limited to, fitness band, smart-watch, wearable physiological monitors and so on. Further, the at least one wearable monitoring device may be configured to detect one or more conditions which are determined to be risk factors for contracting C-Diff. For example, the at least one wearable monitoring device may include an image sensor configured to capture a visual of the individual's stool. Similarly, the at least one wearable monitoring device may include a vibration sensor (e.g. microphone) configured to capture sound patterns and/or bowel movements associated with diarrhea. Likewise, the at least one wearable monitoring device may include a location sensor which may detect past visits to a hospital and/or to a ward with C-Diff infected patients based on correlating geolocation of hospital and/or the ward with that of the location coordinates obtained from the location sensor. Further, the method 400 may include a stage 404 of analyzing the sensor data to determine at least one risk factor associated with C-Diff. For example, analysis of one or more of the image sensor, the vibration sensor and the location sensor may indicate risk factors such as occurrence of diarrhea, a visit to a hospital and/or ward with C-Diff infected patients etc. Further, the method 400 may include a stage 406 of receiving a patient record associated with the individual. The patient record may be retrieved based on a unique identifier associated with the individual (e.g. SSN). Further, the patient record may include information, such as, for example, but not limited to, prescription of antibiotics to the individual. Further, the method 400 may include a stage 408 of analyzing the patient record based on at least one predetermined rule. In general, the at least one predetermined rule may specify patient information regarding C-Diff risk factors (e.g. age, gender, antibiotics consumption etc.). Further, the method 400 may include a stage 410 of generating a C-Diff infection risk for the individual based on the analyzing of the sensor data and the patient record. Accordingly, in some embodiments, the burden on the individual and/or the medical professional for explicitly providing relevant information for determining the C-Diff risk factor may be eliminated, at least partially.

FIG. 5 illustrates a system 502 for determining a risk of contracting C-Diff, in accordance with various embodiments. In some embodiments, the system 502 may be embodied as a computing device (e.g. server computer). The system 502 may include a communication device (not shown in figure) configured to communicate with other devices such as a file-server 504 hosting the patient database. Accordingly, the communication device may be configured to connect to a communication network 506, such as, but not limited to, the Internet. In addition, the communication device may also be configured to communicate with the mobile device 508 associated with the individual 510 and/or a medical professional. Further, the communication device may also be configured to communicate with at least one wearable monitoring device 512 associated with the individual 510. Furthermore, the communication device may also be configured to communicate with at least one standalone monitoring device 514 configured to detect at least one C-Diff risk factor associated with the individual. As a result, the system 502 may receive relevant information from a variety of sources that may be used to automatically determine the C-Diff risk stratification score. Accordingly, the system 502 may further include a processing device configured to analyze the relevant information based on one or more predetermined rules and generate the C-Diff risk stratification score based on the analysis. For example, in some embodiments, the system 502 may receive the plurality of responses to the plurality of assessment questions from the mobile device 508. Accordingly, the processing device may be configured to compute the risk stratification score based on analysis of the plurality of responses. Additionally, the system 502 may include a storage device configured to store the risk stratification score.

FIG. 6 illustrates a user interface configured to present a plurality of assessment questions and receive a plurality of responses in order to determine a risk of contracting C-Diff, in accordance with some embodiments. As shown, the user interface may display the plurality of assessment questions. Further, the user interface may display check-boxes corresponding to YES and NO for each of the plurality of assessment questions. Additionally, the user interface may be configured to receive input from a user (the individual, another user acting on behalf of the individual or a medical professional). Further, the user interface may display a subscore corresponding to each assessment question and a total of the subscores (CDI score) representing the risk stratification score for the individual. Additionally, the user interface may graphically display the subscores on a scale of 0-10. Further, the user interface may include a display of one or more recommendations that are automatically generated based on the risk stratification score. Additionally, the user interface may include features to allow the boxes to be unchecked (‘Uncheck boxes’), transfer the data corresponding to the plurality of responses (‘Transfer Data’) and reset the tool (‘Reset Tool’).

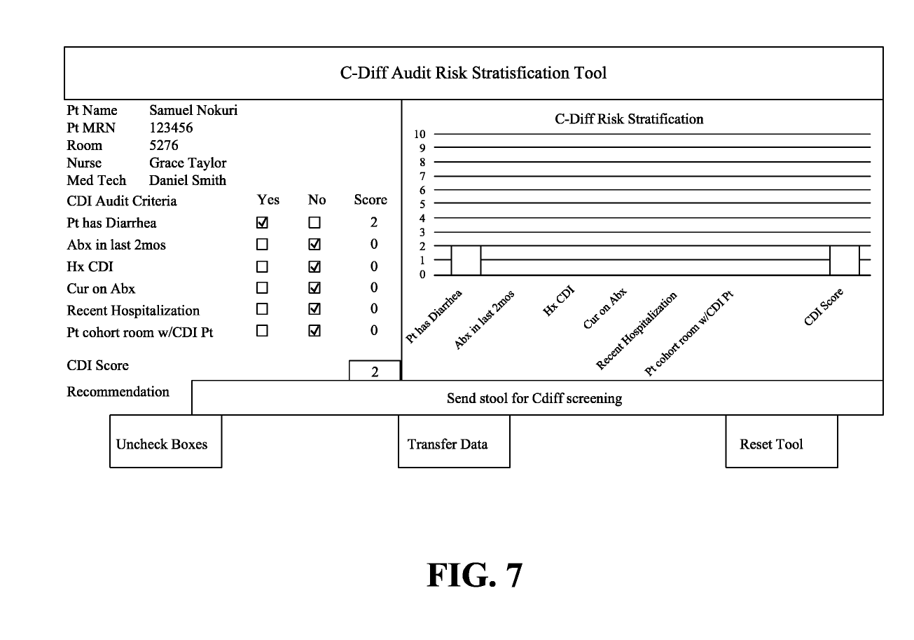

FIG. 7 illustrates a user interface configured to present a risk of contracting C-Diff based on a plurality of responses to a plurality of assessment questions for an exemplary patient, in accordance with some embodiments. As illustrated, the plurality of responses indicates that the individual named Nokuri has experienced diarrhea. Accordingly, the risk stratification score has been computed to be 2 and a corresponding recommendation of “Send stool for C-Diff screening” is displayed.

FIG. 8 illustrates a user interface configured to present a risk of contracting C-Diff based on a plurality of responses to a plurality of assessment questions for another exemplary patient, in accordance with some embodiments. As illustrated the plurality of responses indicates that the individual has experienced diarrhea and consumed antibiotics in the past two months. Accordingly, the risk stratification score has been computed to be 4 and a recommendation of “Put patient on contact isolation, maintain contact precaution and notify provider” is displayed.

According to an exemplary embodiment, the present invention may be embodied as a user friendly application tool that assesses a user's risk for C-diff. Like several other risk stratification tools (CHADVASC score, Well Criteria, etc.), the present invention provides an added level of awareness and enforcement for health care teams to screen and make sure patients with increased risk for C-diff receive the proper treatment and attention needed.

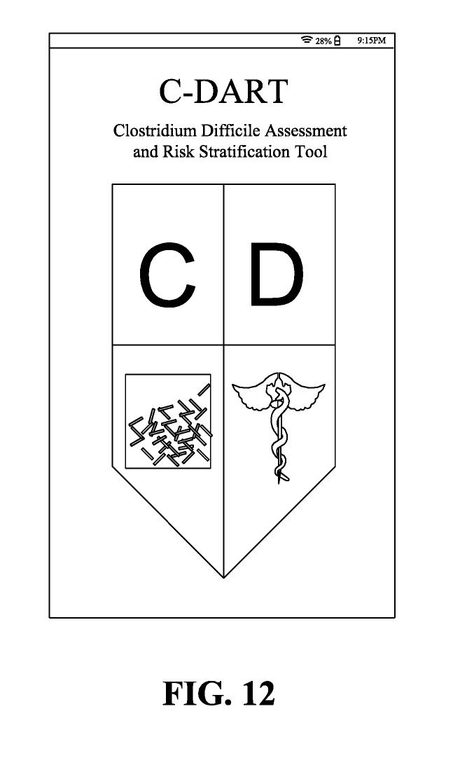

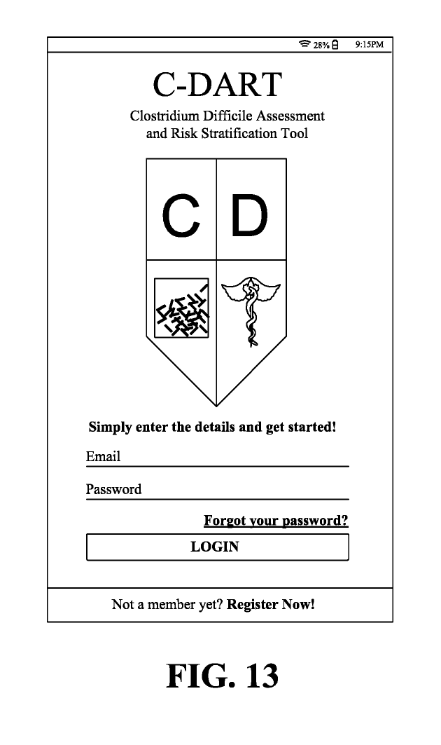

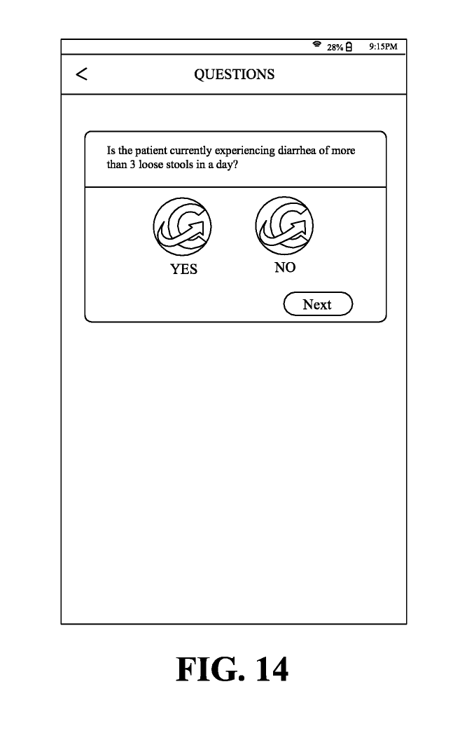

In some embodiments, the present invention may be embodied as a spreadsheet based tool. For instance, an Excel sheet based decision model may provide a set of C-diff auditing criteria. Further, in an instance, there may be two components to the present invention. The first component may be a mobile app (App) which allows the user to enter patient demographic information, enable the user to answer key questionnaires that is weighted, and generates a risk stratification score. Accordingly, when the mobile app is activated, a launching screen as illustrated in FIG. 12 may be presented to the user. Further, as illustrated in FIG. 13, a login screen may be presented to the user. The login screen may include a user interface (e.g. text field) to receive details of a registered user such as name and email address. Further, the login screen may also include a user interface element (e.g. hyperlink) for registering with the mobile app. Subsequently, once the user is logged into the mobile app, a series of assessment questions may be displayed to the user. For example, as illustrated in FIG. 14, the user may be presented with a question along with user interface elements (e.g. buttons) to enable the user to provide a response (e.g. Yes, No, etc.) to the question. Accordingly, based on the responses to the series of questions, the mobile app may calculate and display the risk stratification score.

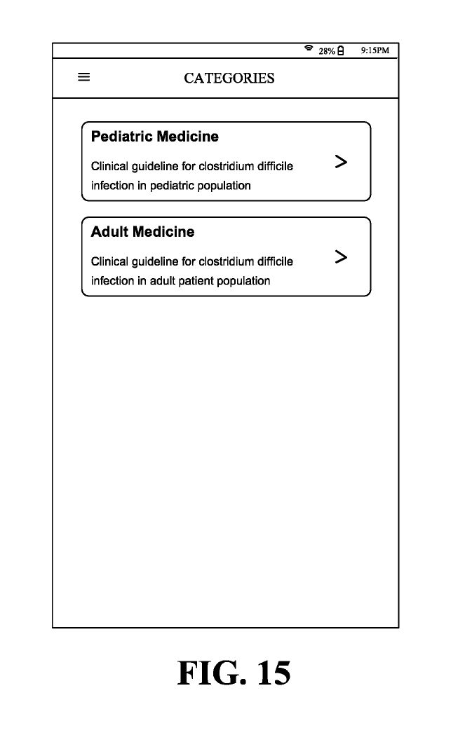

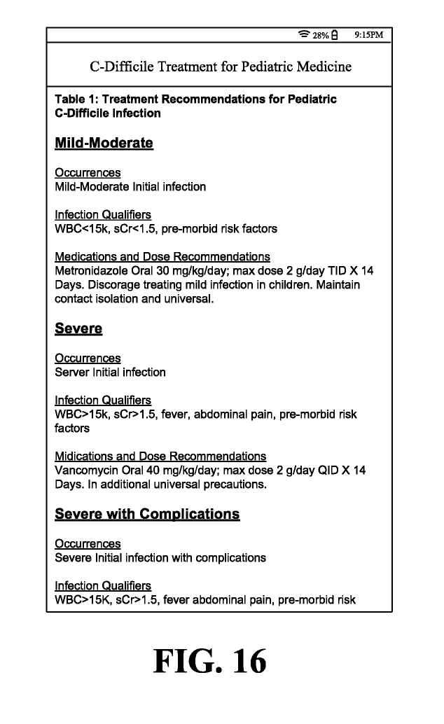

Further, based on the risk stratification score, a recommendation may guide the user on what to do next. In an instance, as illustrated in FIG. 15, the mobile app may display a plurality of categories (e.g. pediatric medicine, Adult medicine etc.) for which guidelines for C-Diff infection is available. Further, upon selecting a category (e.g. pediatric medicine), recommendations may be presented to the user, as exemplarily illustrated in FIG. 16. Another feature is a risk stratification graph which will display which questionnaire is positive and the overall score. The second component is the generation of a C-diff patient list or record database within each unit for census and tracking potential spread. Further, in some instances, the present invention may be embodied as a desktop application as well.

I/We claim:

1. A computer implemented method of determining risk of an individual to contract Clostridium Difficile (C-Diff), the computer implemented method comprising:
presenting, using a presentation device, a plurality of assessment questions corresponding to C-Diff;
receiving, using a processor, a plurality of responses to the plurality of assessment questions, wherein the plurality of responses corresponds to the individual;
receiving, using the processor, demographic information associated with the individual;
analyzing, using the processor, each of the plurality of responses and the demographic information; and
generating, using the processor, a risk stratification score based on the analyzing.

2. The computer implemented method of claim 1, wherein the plurality of assessment questions is associated with a plurality of weights, wherein analyzing the plurality of responses is further based on the plurality of weights.

3. The computer implemented method of claim 1 further comprising receiving, using the processor, clinical information associated with the individual, wherein the generating is further based on analyzing the clinical information.

4. The computer implemented method of claim 3, wherein the clinical information indicates at least one of history of C-Diff infection, immunocompromised disease, inflammatory bowel disease, consumption of antibiotics and consumption of proton pump inhibitors.

5. The computer implemented method of claim 3, wherein the clinical information indicates at least one of a frequency of diarrhea, abdominal pain, fever accompanied with increased white blood cell count, renal impairment, lactic acidosis, and low albumin level.

6. The computer implemented method of claim 1 further comprising generating, using the processor, a recommendation based on the risk stratification score.

7. The computer implemented method of claim 6, wherein the recommendation comprises at least one of a laboratory test, an imaging, and a treatment regimen.

8. The computer implemented method of claim 1, wherein the plurality of responses is repeatedly obtained at a plurality of time instants, wherein a plurality of risk stratification scores corresponding to the plurality of time instants is generated by the processor.

9. The computer implemented method of claim 8 further comprising identifying, using the processor, a trend in the plurality of risk stratification scores.

10. The computer implemented method of claim 1 further comprising:
updating, using the processor, a database of patient records with the risk stratification score, wherein each patient record comprises a corresponding risk stratification score;
analyzing, using the processor, the database of patient records; and
determining, using the processor, a potential spread of C-Diff infection based on the analyzing of the database of patient records.

11. A system for determining risk of an individual to contract Clostridium Difficile (C-Diff), the system comprising:
a communication device configured to:
transmit a plurality of assessment questions to a user device, wherein the plurality of assessment questions corresponds to C-Diff, wherein the user device is configured to present the plurality of assessment questions;
receive a plurality of responses to the plurality of assessment questions from the user device, wherein the plurality of responses corresponds to the individual;
receive demographic information associated with the individual; and
a processing device configured to:
analyze each of the plurality of responses and the demographic information; and
generate a risk stratification score based on the analyzing.

12. The system of claim 11, wherein the plurality of assessment questions is associated with a plurality of weights, wherein the processing device is further configured to analyze the plurality of responses based on the plurality of weights.

13. The system of claim 11, wherein the communication device is further configured to receive clinical information associated with the individual, wherein the processing device is further configured to generate the risk stratification score based on the clinical information.

14. The system of claim 13, wherein the clinical information indicates at least one of history of C-Diff infection, immunocompromised disease, inflammatory bowel disease, consumption of antibiotics and consumption of proton pump inhibitors.

15. The system of claim 13, wherein the clinical information indicates at least one of a frequency of diarrhea, abdominal pain, fever accompanied with increased white blood cell count, renal impairment, lactic acidosis and low albumin level.

16. The system of claim 11, wherein the processing device is further configured to generate a recommendation based on the risk stratification score.

17. The system of claim 16, wherein the recommendation comprises at least one of a laboratory test, an imaging, and a treatment regimen.

18. The system of claim 11, wherein the plurality of responses is repeatedly obtained at a plurality of time instants, wherein a plurality of risk stratification scores corresponding to the plurality of time instants is generated by the processor.

19. The system of claim 18, wherein the processing device is further configured to identify a trend in the plurality of risk stratification scores.

20. The system of claim 11, wherein the processing device is further configured to:
update a database of patient records with the risk stratification score, wherein each patient record comprises a corresponding risk stratification score;
analyze the database of patient records; and
determine a potential spread of C-Diff infection based on the analysis of the database of patient records.
